(19) United States
(12) Patent Application Publication
(10) Pub. No.: US 2014/0164466 A1
(43) Pub. Date: Jun. 12, 2014

(54) DATA TRANSFORMATION DEVICE, DATA TRANSFORMATION METHOD, AND PROGRAM

(71) Applicant: SAMSUNG DISPLAY CO., LTD., Yongin-City (KR)

(72) Inventor: Isamu RYU, Yokohama (JP)

(21) Appl. No.: 14/103,180

(22) Filed: Dec. 11, 2013

(30) Foreign Application Priority Data
Dec. 11, 2012 (JP) 2012-270828

(51) Int. Cl. G06F 17/16

(52) U.S. Cl. CPC G06F 17/16
USPC 708/520; 708/607

(57) ABSTRACT

A data transformation device defines a first square submatrix of an m order (m≧2) including elements (n, n) in the matrixes A and F being detA≠1 and A=GHₙHₙ₋₁ . . . H₁=GF, calculates a first element in the matrix Hi based on elements in a lowest order row of the first square submatrix, defines a second square submatrix of a (m+1) order, and calculates a second element in the matrix Hᵢ based on elements in a lowest order row of the second square submatrix and the first element. The data transformation device calculates all elements in the matrix Hi by iterating processing on the second element until the second square submatrix becomes an n order and calculates elements of the matrix G using elements of matrix A and matrix H₁. Then, variable transformation is performed to solve a linear system including n variables and n equations.

### CROSS-REFERENCE TO RELATED APPLICATION

Japanese Patent Application No. 2012-270828, filed on Dec. 11, 2012, in the Korean Intellectual Property Office, and entitled: “DATA TRANSFORMATION DEVICE, DATA TRANSFORMATION METHOD AND PROGRAM,” is incorporated by reference herein in its entirety.

### BACKGROUND

1. Field

Embodiments relate to a data transformation device, a data transformation method, and a program, and, more particularly, relate to a matrix factorization technique for use with a lifting scheme.

2. Description of the Related Art

Various methods for performing integer reversible transformation of non-orthogonal transformation (e.g., rotation transformation accompanying a variation in the size), reversible compression of data (typically, images, moving pictures, voices, etc.) are used.

The following equation (1) includes orthogonal transformation and is frequently used for data transformation.

Y=AX (1)

In most cases, a rank of a transformation matrix A may be a real number. Since an application necessitating reversible transformation requires high calculation accuracy, ideally, a transformation rank would have an infinite word length. However, when the transformation equation (1) is applied to an information processing device, such use is impractical. Instead, a word length having a finite transformation rank or a rounding operation is used. A lifting scheme, which generates an error that is complementary between forward transformation and reverse transformation, i.e., allows for perfect reconstruction, may play an important role.

The following equations (2) and (3) may be basic forms of the lifting scheme.

$$\begin{matrix}B = [ \begin{matrix}1 & b \\ 0 & 1\end{matrix} ] or B = [ \begin{matrix}1 & 0 \\ b & 1\end{matrix} ] & ( 2 ) \\ {B}^{- 1} = [ \begin{matrix}1 & - b \\ 0 & 1\end{matrix} ] or {B}^{- 1} = [ \begin{matrix}1 & 0 \\ - b & 1\end{matrix} ] & ( 3 )\end{matrix}$$

Here, with BB⁻¹=E, although a rank ‘b’ is rounded, an error may be complementary between forward transformation and reverse transformation. Therefore, a transformation matrix A may be factorized into a form expressed by the equation (2). However, current methods for factorizing the transformation matrix A must satisfy a condition detA=1 and/or when used on a four-dimensional or high-dimensional orthogonal matrix, the number of variables sharply increases.

### SUMMARY

One embodiment is directed to provide a data transformation device which factorizes an n-dimensional transformation matrix A (detA≠1) in a format to which a lifting scheme is applicable, the transformation matrix A being factorized to the following equation (1) including an n-dimensional square matrix G, F, and Hᵢ (Hₙ, Hₙ₋₁, . . . , H₁),

A=GHₙHₙ₋₁ . . . H₁=GF (1),

the matrix G being a matrix including ‘1’ as diagonal elements, (g1, g2, . . . , gn−1, 1) as elements in a row of a highest order, and ‘0’ as remaining elements, and the matrix Hi being a matrix including ‘1’ as diagonal elements, (hᵢ₁, hᵢ₂, . . . , hᵢₙ₋₁, 1) as elements in a row of a (n−i+1) order, and ‘0’ as remaining elements. The data transformation device comprises a storage unit which stores the matrix A; and a processing unit which acquires the matrix A from the storage unit, defines a first square submatrix of an m order (m≧2) including elements (n, n) in the matrix A and the matrix F, calculates a first element included in the matrix Hᵢ based on elements included in a row of a lowest order of the first square submatrix, defines a second square submatrix of a (m+1) order including the elements (n, n) in the matrix A and the matrix F, calculates a second element included in the matrix Hᵢ based on elements included in a row of a lowest order of the second square submatrix and the first element, calculates all elements included in the matrix Hi by iterating processing on the second element until the second square submatrix becomes an n order, and calculates elements of the matrix G using elements of the matrix A and the matrix H₁, wherein when calculating the elements of the matrix G, the processing unit performs variable transformation to solve a linear system including n variables and n equations.

Another embodiment is directed to provide a data transformation method which factorizes an n-dimensional transformation matrix A (detA≠1) in a format to which a lifting scheme is applicable, the transformation matrix A being factorized to the following equation (1) including an n-dimensional square matrix G, F, and Hi (Hₙ, Hₙ₋₁, . . . , H₁),

A=GHₙHₙ₋₁ . . . H₁=GF (1),

the matrix G being a matrix including ‘1’ as diagonal elements, (g1, g2, . . . , gn−1, 1) as elements in a row of a highest order, and ‘0’ as remaining elements, and the matrix Hᵢ being a matrix including ‘1’ as diagonal elements, (hᵢ₁, hᵢ₂, . . . , hᵢₙ₋₁, 1) as elements in a row of a (n−i+1) order, and ‘0’ as remaining elements. The data transformation method includes acquiring the matrix A; defining a first square submatrix of an m order (m≧2) including elements (n, n) in the matrix A and the matrix F; calculating a first element included in the matrix Hᵢ based on elements included in a row of a lowest order of the first square submatrix; defining a second square submatrix of a (m+1) order including the elements (n, n) in the matrix A and the matrix F; calculating a second element included in the matrix H₁ based on elements included in a row of a lowest order of the second square submatrix and the first element; calculating all elements included in the matrix Hi by iterating processing on the second element until the second square submatrix becomes an n order; and calculating elements of the matrix G using elements of the matrix A and the matrix H₁, wherein when the elements of the matrix G are calculated, variable transformation is performed to solve a linear system including n variables and n equations.

### BRIEF DESCRIPTION OF THE DRAWINGS

Features will become apparent to those of skill in the art by describing in detail exemplary embodiments with reference to the attached drawings in which:

FIG. 1 illustrates a block diagram of a data transformation device according to a first embodiment.

FIG. 2 illustrates a flowchart showing an operation of a data transformation device according to a first embodiment.

FIG. 3 illustrates a flowchart showing an operation of a data transformation device according to a second embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

### First Embodiment

A first embodiment discloses a method of factorizing a four-dimensional transformation matrix A.

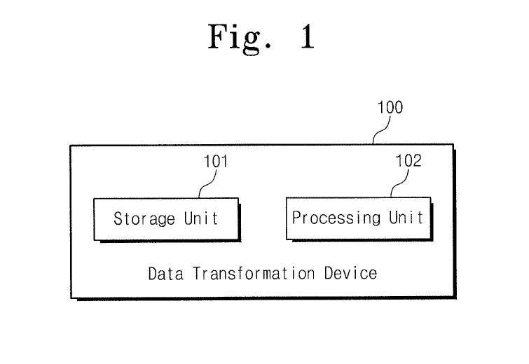

A data transformation device 100 according to an embodiment is described using a block diagram shown in FIG. 1. A data transformation device 100 may include a storage unit 101 and a processing unit 102. The storage unit 101 may store data needed for an operation of the processing unit 102, output data processed by the processing unit 102, a program including a processing algorithm, and the like. For example, data needed for an operation of the processing unit 102 may include input data as a transformation target, i.e., a transformation matrix A. The processing unit 102 may read data needed for a processing operation and a program from the storage unit 101 and transform input data using the transformation matrix A according to a corresponding program. The processing unit 102 may store a processed result in the storage unit 101.

The data transformation device 100 may be a computer, e.g., a personal computer, and may include a volatile memory or a nonvolatile memory as the storage unit 101 and a central processing unit (CPU) as the processing unit 102.

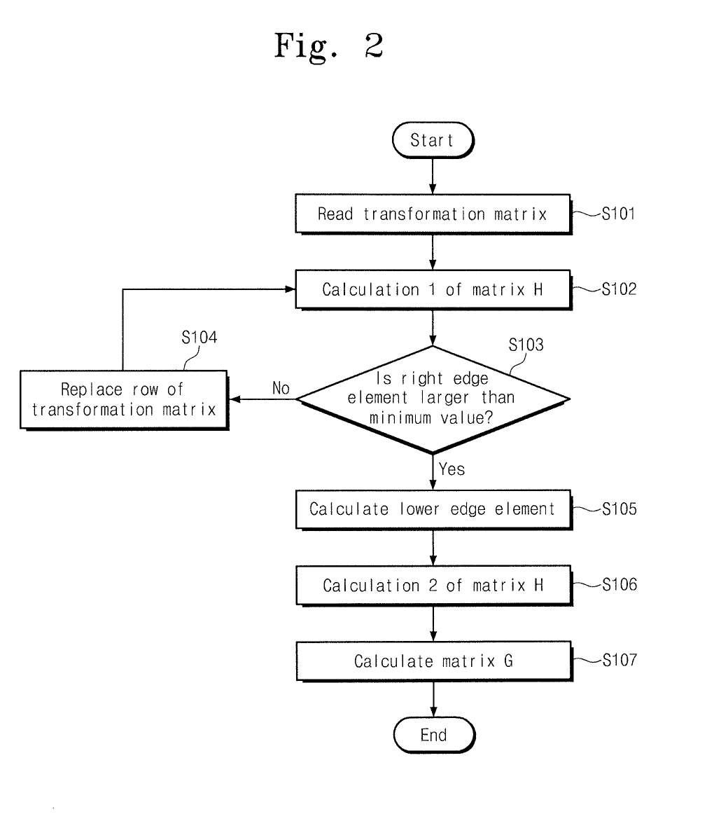

An operation of the data transformation device 100 is described with reference to a flow chart show in FIG. 2.

In operation S101, the processing unit 102 may acquire a transformation matrix A from the storage unit 101. Here, the transformation matrix A may be a four-dimensional matrix and may be expressed by the following equation (4).

$$A = [ \begin{matrix}a 11 & a 12 & a 13 & a 14 \\ a 21 & a 22 & a 23 & a 24 \\ a 31 & a 32 & a 33 & a 34 \\ a 41 & a 42 & a 43 & a 44\end{matrix} ] \qquad ( 4 )$$

Here, the transformation matrix A may be factorized as the following equation (5). In the equation (5), matrixes H₁ to H₄, G and F may be expressed by the following equations (6) to (11).

$$\begin{matrix}A = G {H}_{4} {H}_{3} {H}_{2} {H}_{1} = GF & ( 5 ) \\ {H}_{1} = [ \begin{matrix}1 & 0 & 0 & 0 \\ o & 1 & 0 & 0 \\ o & 0 & 1 & 0 \\ h 11 & h 12 & h 13 & 1\end{matrix} ] & ( 6 ) \\ {H}_{2} = [ \begin{matrix}1 & 0 & 0 & 0 \\ 0 & 1 & 0 & 0 \\ h 21 & h 22 & 1 & h 24 \\ 0 & 0 & 0 & 1\end{matrix} ] & ( 7 ) \\ {H}_{3} = [ \begin{matrix}1 & 0 & 0 & 0 \\ h 31 & 1 & h 33 & h 34 \\ 0 & 0 & 1 & 0 \\ 0 & 0 & 0 & 1\end{matrix} ] & ( 8 ) \\ {H}_{4} = [ \begin{matrix}1 & h 42 & h 43 & h 44 \\ 0 & 1 & 0 & 0 \\ 0 & 0 & 1 & 0 \\ 0 & 0 & 0 & 1\end{matrix} ] & ( 9 ) \\ G = [ \begin{matrix}1 & 0 & 0 & 0 \\ 0 & 1 & 0 & 0 \\ 0 & 0 & 1 & 0 \\ g 1 & g 2 & g 3 & 1\end{matrix} ] & ( 10 )\end{matrix}$$

Below, matrix elements (h11, h12, h13) may be referred to as lower edge elements and matrix elements (h24, h34, h44) may be referred to as right edge elements.

It is understood from the equations (5) to (10) that elements included in boxes of matrixes A and F marked by dotted lines in the following equation (11) have the same value.

$$\begin{matrix}A = [ \begin{matrix}\begin{matrix}a 11 & a 12 & a 13 & a 14 \\ a 21 & a 22 & a 23 & a 24 \\ a 31 & a 32 & a 33 & a 34\end{matrix} \\ a 41 \begin{matrix} a 42 & a 43 & a 44\end{matrix}\end{matrix} ] & A = [ \begin{matrix}\begin{matrix}f 11 & f 12 & f 13 & f 14 \\ f 21 & f 22 & f 23 & f 24 \\ f 31 & f 32 & f 33 & f 34\end{matrix} \\ h 11 \begin{matrix} h 12 & h 13 & 1\end{matrix}\end{matrix} ]\end{matrix} \qquad ( 11 )$$

The following simultaneous equations (12) to (17) may be set up from the equations (5) to (10).

h24=a34 (12)

1+h24h13=a33 (13)

h22+h24h12=a32 (14)

h33h24+h34=a24 (15)

h33(1+h24h13)+h34h13=a23 (16)

1+h33(h22+h24h12)+h34h12=a22 (17)

In operation S102, the processing unit 102 may calculate matrix elements (h13, h24), (h12, h33, h34), and (h11, h42, h43, h44) (calculation 1 of the matrix H).

First, the processing unit 102 may calculate matrix elements (h13, h24) from elements included in a box marked by a dotted line of the following equation (18).

$$\begin{matrix}A = [ \begin{matrix}\begin{matrix}a 11 & a 12 \\ a 21 & a 22\end{matrix} & \begin{matrix}a 13 & a 14 \\ a 23 & a 24\end{matrix} \\ \begin{matrix}a 31 & a 32 \\ a 41 & a 42\end{matrix} & \begin{matrix}a 33 & a 34 \\ a 43 & a 44\end{matrix}\end{matrix} ] & F = [ \begin{matrix}\begin{matrix}f 11 & f 12 \\ f 21 & f 22\end{matrix} & \begin{matrix}f 13 & f 14 \\ f 23 & f 24\end{matrix} \\ \begin{matrix}f 31 & f 32 \\ h 11 & h 12\end{matrix} & \begin{matrix}f 33 & f 34 \\ h 13 & 1\end{matrix}\end{matrix} ]\end{matrix} \qquad ( 18 )$$

In other words, the processing unit 102 may calculate elements (h13, h24) by solving the simultaneous equations (12) and (13). For example, the processing unit 102 may solve the simultaneous equations (12) and (13) using a well-known solution algorithm.

Then, the processing unit 102 may calculate matrix components (h12, h22, h33, h34) using a solution of a linear system set up based on underlined elements of the following equation (19) and the previously calculated matrix elements (h13, h24).

$$\begin{matrix}A = [ \begin{matrix} a 11 a 12 a 13 a 14 \\ \begin{matrix}a 21 \\ a 31 \\ a 41\end{matrix} \begin{matrix}\underline{a 22 a 23 a 24} \\ a 32 a 33 a 34 \\ a 42 a 43 a 44\end{matrix}\end{matrix} ] & F = [ \begin{matrix}f 11 f 12 f 13 f 14 \\ \begin{matrix}f 21 \\ f 31 \\ h 11\end{matrix} \begin{matrix}\underline{f 22 f 23 f 24} \\ f 32 f 33 f 34 \\ h 12 h 13 \; 1\end{matrix}\end{matrix} ]\end{matrix} \qquad ( 19 )$$

A detailed calculation order of (h12, h22, h33, h34) may be as follows.

The processing unit 102 may calculate (h33, h34) from a lower edge element h13 previously calculated using the equations (13), (15) and (16).

The processing unit 102 may calculate a lower edge element h12 from elements (h13, h33, h34) previously calculated and the equations (14) and (17). At this time, division may be generated by a right edge element h34. However, in the event that an absolute value of h34 is small, i.e., smaller than a minimum value the processing unit 102 is capable of dividing, a division error may be generated. In this case, the lower edge element h12 may be diverged, i.e., the row of the transformation matrix may be adjusted. Thus, the processing unit 102 may perform an operation corresponding to operation S104 only such a case, as determined by operation S103.

The division error may come from (a33, a34) and (a23, a24). Partial pivot selection of a Gauss elimination method may be used to avoid the division error. Here, (a33, a34) may not be changed, as they are used to calculate the lower edge element h13, as described above. Here, partial pivot selection of the Gauss elimination method may be performed with respect to (a23, a24). In exemplary embodiments, the partial pivot selection may be performed by replacing (a21, a22, a23, a24) and (all, a12, a13, a14) in operation S104. In this manner, the processing unit 102 may calculate the lower edge element h12 in operation S105 without generation of the division error.

The processing unit 102 may calculate an element h22 from a lower edge element h12 previously calculated using the equations (12) and (14) in operation S106.

Then, the processing unit 102 may calculate matrix components (h11, h21, h31, h42, h43, h44) using a solution of a linear system set up based on underlined elements of the following equation (20) and the previously calculated matrix elements (h13, h24) and (h12, h22, h33, h34).

$$\begin{matrix}A = [ \begin{matrix}\underline{a 11 a 12 a 13 a 14} \\ a 21 a 22 a 23 a 24 \\ a 31 a 32 a 33 a 34 \\ a 41 a 42 a 43 a 44\end{matrix} ] & F = [ \begin{matrix}\underline{f 11 f 12 f 13 f 14} \\ f 21 f 22 f 23 f 24 \\ f 31 f 32 f 33 f 34 \\ h 11 h 12 h 13 \; 1\end{matrix} ]\end{matrix} \qquad ( 20 )$$

A detailed calculation order of (h11, h21, h31, h42, h43, h44) is as follows.

In connection with the elements, a simultaneous equation may be set up using relations of the equations (12) to (17) and underlined elements of the equation (20). The processing unit 102 may solve the simultaneous equation according to an order described with reference to operations S102 to S105. Thus, the processing unit 102 may calculate (h42, h43, h44) and a lower edge element h11.

In operation S106, the processing unit 102 may calculate (h21, h31) from the lower edge element h11 previously calculated using the equations (12) to (17).

Thus, in operation S106, the processing unit 102 may calculate matrix elements h22 and (h21, h31) (calculation 2 of the matrix H). The matrix elements h22 and (h21, h31) may be calculated in the same manner as described above.

In operation S107, the processing unit 102 may determine the matrix G, i.e., an operation for calculating matrix elements (g1, g2, g3) may be performed. In particular, the matrix elements (g1, g2, g3) may be determined from the following equations (21) to (24). The equations (21) to (24) may be deduced from the equations (5) to (10).

a11g1+a21g2+a31g3+h11=a41 (21)

a12g1+a22g2+a32g3+h12=a42 (22)

a13g1+a23g2+a33g3+h13=a43 (23)

a14g1+a24g2+a34g3+1=a44 (24)

The equations (21) to (24) may be an overdetermined linear system including four equations and three variables. In general, when detA=1, elements (g1, g2, g3) may be calculated using three equations of the four equations, and all conditions may be finally satisfied. However, when detA≠1, the above method cannot be used. In general, an optimal solution may be calculated by the method of least squares. However, since the optimal solution thus obtained is different from a true solution, such a problem that the equation (5) is not set up by influence of an error may be generated. In accordance with embodiments, a linear equation including four variables and four equations may be set up through the following variable transformation. Thus, a true solution of (g1, g2, g3) may be obtained.

That is, the processing unit 102 may calculate (g1, g2, g3) by performing variable transformation using the following equation (25) and then solving a linear system including four variables and four equations shown in the following equation (26).

$$\begin{matrix} [ \begin{matrix}g 1 \\ g 2 \\ g 3\end{matrix} ] = [ \begin{matrix}a 11 & a 12 & a 13 & a 14 \\ a 21 & a 22 & a 23 & a 24 \\ a 31 & a 32 & a 33 & a 34\end{matrix} \vert ] [ \begin{matrix}λ 1 \\ λ 2 \\ λ 3 \\ λ 4\end{matrix} ] & ( 25 ) \\ [ \begin{matrix}a 11 & a 21 & a 31 \\ a 12 & a 22 & a 32 \\ a 13 & a 23 & a 33 \\ a 14 & a 24 & a 34\end{matrix} ] [ \begin{matrix}a 11 & a 12 & a 13 & a 14 \\ a 21 & a 22 & a 23 & a 24 \\ a 31 & a 32 & a 33 & a 34\end{matrix} ] [ \begin{matrix}λ 1 \\ λ 2 \\ λ 3 \\ λ 4\end{matrix} ] = [ \begin{matrix}a 41 - h 11 \\ a 42 - h 12 \\ a 43 - h 13 \\ a 44 - 1\end{matrix} ] & ( 26 )\end{matrix}$$

Finally, the processing unit 102 may output the matrixes G and F to the storage unit 101. Afterwards, the procedure may end.

There is described an embodiment where matrix factorization is performed with respect to a four-dimensional transformation matrix A. However, if processing is performed in a loop order according to a dimension of a transformation matrix, a five-dimensional or higher-dimensional transformation matrix may be factorized. That is, it is possible to apply an integer reversible transformation technique using a lifting scheme to a high-dimensional transformation matrix.

In accordance with embodiments, a high-dimensional transformation matrix A having a condition of detA≠1 may be factorized using a format to which the lifting scheme is applied. Therefore, integer reversible transformation such as rotation transformation, affine transformation, etc., accompanying a variation in the size may be possible. In particular, the rotation transformation accompanying a variation in the size may be an important technique for reversible data compression.

### Second Embodiment

In a second embodiment, the above-described data transformation device 100 may be applied to vector rotation. In conventional reversible data compression, a compression ratio may be dependent on data. Here, data dependency of the compression ratio may mean a difference of compression ratios due to a data distribution characteristic. Therefore, application of the conventional reversible data compression may be restricted. The reason is that a compression ratio is irregular. That is, a storage device or a capacity of a communication path may be designed based on a worst case scenario. However, data dependency may be reduced using vector rotation. The reason is that if any vector is rotated to overlap an ideal vector suitable for compression, a distribution characteristic of the vector is approximate to that of the ideal vector. Thus, a variation in a compression ratio may be reduced.

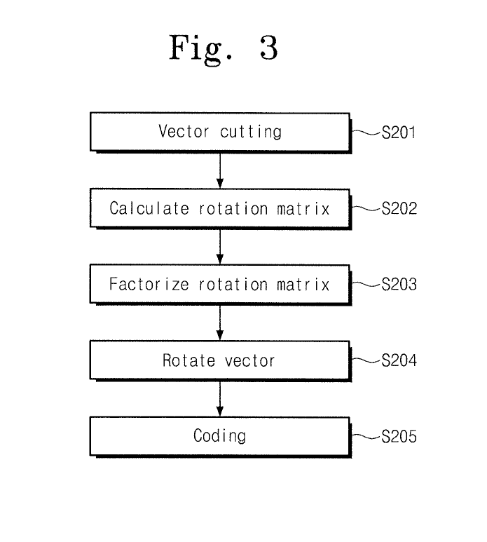

An operation of a data transformation device 100 according to a second embodiment is described with reference to a flow chart shown in FIG. 3. Also, a data transformation device 100 according to a second embodiment of the inventive concepts is configured substantially the same as a data transformation device 100 according to a first embodiment.

In operation S201, a processing unit 102 may read some (e.g., 16) of input data stored in a storage unit 101. Here, each input data may be a vector (or, an input vector), and a set of vectors may be formed by the read input vectors.

In operation S202, the processing unit 102 may calculate a rotation matrix of an input vector. If an input vector can be rotated to overlap with a reference vector (e.g., a pivot vector P=[P₀, 0, 0, . . . 0, 0, 0]), the number of signs may be theoretically constant, regardless of an input vector. However, the number of rotation matrixes is enormous, since it is equal to the number of input vectors. Therefore, quantization of a rotation matrix, i.e., to use a common rotation matrix between vectors whose difference is small, may be required to reduce the number of rotation matrixes. When a rotation matrix is quantized, a quantization error due to a rotated input vector that does not easily overlap a reference vector may be generated, since a plurality of input vectors share a rotation matrix.

The quantization error may be proportional to the size of an input vector. Thus, the quantization error may be reduced by multiplying a constant scale coefficient and an input vector.

Assuming that a reference vector is a unit pivot vector U (=[U₀, 0, 0, . . . 0, 0, 0]), an input vector may be multiplied by a scale coefficient such that the size becomes, e.g., ‘1’. However, since the number of scale coefficients is huge, quantization may be required.

If the number of operations for quantizing the scale coefficients is reduced, a quantization error of a rotation matrix may be suppressed. However, this may result in a loss of compression ratio due to an increase in the number of scale coefficients. Therefore, the number of scale coefficients may be adjusted using a number of cut samples.

The processing unit 102 may calculate a rotation matrix according to a quantization operation of the rotation matrix and a quantization operation of the scale coefficient. More particular, the processing unit 102 may calculate the rotation matrix through matrix factorization.

The processing unit 102 may factorize the rotation matrix thus calculated to have a format to which a lifting scheme may be applied in the same manner as described with reference to the first embodiment.

In operation S204, the processing unit 102 may rotate the input vector until a shape approximate to the unit pivot vector using the rotation vector having a format to which a lifting scheme may be applied.

In operation S205, the processing unit 102 may encode the rotated input vector using an encoding technique (e.g., differential coding, arithmetic coding, etc.). Since rotation processing is reversible, an original input vector may be obtained through decoding and reverse rotation.

By way of summation and review, as compared with the conventional reversible data compression, embodiments may be advantageous in that data dependency of a compression ratio is low. Further, according to embodiments, an integer reversible transformation may be applied to a high-dimensional transformation matrix A that is not orthogonal (|detA|≠1). That is, a matrix may be factorized such that a lifting scheme may be used.

While exemplary embodiments have been described, it will be apparent to those skilled in the art that various changes and modifications may be made without departing from the spirit and scope of the present disclosure. Therefore, it should be understood that the above embodiments are not limiting, but illustrative.

For example, in the above-described embodiments, embodiments are described using hardware components. However, any process described above may be performed by executing a computer program on a central processing unit (CPU). In this case, the computer program may be stored using a non-transitory computer readable medium and supplied to a computer. The non-transitory computer readable medium may include a tangible storage medium. The non-transitory computer readable medium may include a magnetic record medium (e.g., a flexible disk, a magnetic disk, a hard disk drive, etc.), a magnet-optical medium (e.g., a magnet-optical disk), CD-ROM (Read Only Memory), CD-R, CD-R/W, and a semiconductor memory (e.g., a mask ROM, ROM, PROM (Programmable ROM), EPROM (Erasable PROM), flash ROM, RAM (Random Access Memory)) Also, a program may be supplied to a computer using a transitory computer readable medium. The transitory computer readable medium may include an electrical signal, an optical signal, and an electromagnetic wave. The transitory computer readable medium may supply a program to a computer through a wire communication path (e.g., an electric wire, an optical fiber, etc.) or a wireless communication path.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A data transformation device which factorizes an n-dimensional transformation matrix A (detA≠1) in a format to which a lifting scheme is applicable, the transformation matrix A being factorized to the following equation (1) including an n-dimensional square matrix G, F, and Hᵢ (Hₙ, Hₙ₋₁, . . . , H₁),
A=GHₙHₙ₋₁ . . . H₁=GF (1),
the matrix G being a matrix including ‘1’ as diagonal elements, (g1, g2, . . . , gn−1, 1) as elements in a row of a highest order, and ‘0’ as remaining elements, and the matrix Hi being a matrix including ‘1’ as diagonal elements, (hᵢ₁, hᵢ₂, . . . , hᵢₙ₋₁, 1) as elements in a row of a (n−i+1) order, and ‘0’ as remaining elements, the data transformation device comprising:
a storage unit which stores the matrix A; and
a processing unit which acquires the matrix A from the storage unit, defines a first square submatrix of an m order (m≧2) including elements (n, n) in the matrix A and the matrix F, calculates a first element included in the matrix Hᵢ based on elements included in a row of a lowest order of the first square submatrix, defines a second square submatrix of a (m+1) order including the elements (n, n) in the matrix A and the matrix F, calculates a second element included in the matrix Hᵢ based on elements included in a row of a lowest order of the second square submatrix and the first element, calculates all elements included in the matrix Hi by iterating processing on the second element until the second square submatrix becomes an n order, and calculates elements of the matrix G using elements of the matrix A and the matrix H₁,
wherein, when calculating the elements of the matrix G, the processing unit performs variable transformation to solve a linear system including n variables and n equations.

2. The data transformation device as claimed in claim 1, wherein the processing unit performs the variable transformation using the following equations (2) and (3),
$$\begin{matrix} [ \begin{matrix}g 1 \\ g 2 \\ g 3\end{matrix} ] = [ \begin{matrix}a 11 & a 12 & a 13 & a 14 \\ a 21 & a 22 & a 23 & a 24 \\ a 31 & a 32 & a 33 & a 34\end{matrix} \vert ] [ \begin{matrix}λ 1 \\ λ 2 \\ λ 3 \\ λ 4\end{matrix} ] & ( 2 ) \\ [ \begin{matrix}a 11 & … & a ( n - 1 ) 1 \\ ⋮ & … & ⋮ \\ ⋮ & … & ⋮ \\ a 1 ( n - 1 ) & … & a 3 ( n - 1 ) \\ a 1 n & … & a 3 n\end{matrix} ] [ \begin{matrix}a 11 & a 12 & … & a 1 n \\ ⋮ & ⋮ & … & ⋮ \\ ⋮ & ⋮ & … & ⋮ \\ a ( n - 1 ) 1 & a ( n - 1 ) 2 & … & a ( n - 1 ) n\end{matrix} ] [ \begin{matrix}λ 1 \\ λ 2 \\ ⋮ \\ ⋮ \\ λ n\end{matrix} ] = [ \begin{matrix}an 1 - h 11 \\ an 2 - h 12 \\ ⋮ \\ ⋮ \\ ann - 1\end{matrix} ] . & ( 3 )\end{matrix}$$

3. The data transformation device as claimed in claim 2, wherein the processing unit outputs at least one of the matrixes G and F to the storage unit.

4. A data transformation method which factorizes an n-dimensional transformation matrix A (detA≠1) in a format to which a lifting scheme is applicable, the transformation matrix A being factorized to the following equation (1) including an n-dimensional square matrix G, F, and Hi (Hₙ, Hₙ₋₁, . . . , H₁),
A=GHₙHₙ₋₁ . . . H₁=GF (1),
the matrix G being a matrix including ‘1’ as diagonal elements, (g₁, g₂, . . . , gₙ₋₁, 1) as elements in a row of a highest order, and ‘0’ as remaining elements, and the matrix Hᵢ being a matrix including ‘1’ as diagonal elements, (hᵢ₁, hᵢ₂, . . . , hᵢₙ₋₁, 1) as elements in a row of a (n−i+1) order, and ‘0’ as remaining elements, the data transformation method comprising:
acquiring the matrix A;
defining a first square submatrix of an m order (m≧2) including elements (n, n) in the matrix A and the matrix F;
calculating a first element included in the matrix Hi based on elements included in a row of a lowest order of the first square submatrix;
defining a second square submatrix of a (m+1) order including the elements (n, n) in the matrix A and the matrix F;
calculating a second element included in the matrix Hi based on elements included in a row of a lowest order of the second square submatrix and the first element;
calculating all elements included in the matrix Hi by iterating processing on the second element until the second square submatrix becomes an n order; and
calculating elements of the matrix G using elements of the matrix A and the matrix H₁,
wherein when the elements of the matrix G are calculated, variable transformation is performed to solve a linear system including n variables and n equations.

5. A program executing a data transformation method as claimed in claim 4 on a computer.
